(19) United States
(12) Patent Application Publication
(10) Pub. No.: US 2016/0368155 A1
(43) Pub. Date: Dec. 22, 2016

(54) Knife Clip

(71) Applicant: Marfione Custom Knives, LLC, Bradford, PA (US)

(72) Inventors: Andrew Mark Mandeville, Candler, NC (US); Anthony L. Marfione, Asheville, NC (US)

(73) Assignee: Marfione Custom Knives, LLC, Bradford, PA (US)

(21) Appl. No.: 15/183,882

(22) Filed: Jun. 16, 2016

Related U.S. Application Data
(60) Provisional application No. 62/180,281, filed on Jun. 16, 2015.

(51) Int. Cl. B26B 1/04; B26B 1/10

(52) U.S. Cl. CPC B26B 1/04; B26B 1/10

(57) ABSTRACT

A clip assembly for use in combination with a knife includes a housing; an elongated clip that is sized and configured for congruent receipt in the housing, the elongated clip having a proximal end and a distal end, and the elongated clip being securable to the housing by at least one clip pivot being located in a through hole near the proximal end of the elongated clip and extending the width of the elongated clip; a button spring held against the elongated clip for biasing the elongated clip toward a resting position, and the elongated clip being operational between the resting position and an open position by depressing the distal end of the elongated clip thereby causing the proximal end to pivotally rise; and first and second oppositely disposed access recesses on the housing each being sized and configured for permitting access to the at least one clip pivot when the elongated clip is in the open position for selective removal of the at least one clip pivot, the button spring and the elongated clip.

This application is based on and claims priority to provisional patent application No. 62/180,281 filed on Jun. 16, 2015.

### BACKGROUND OF THE INVENTION

Field of the Invention

This invention relates to knives and, more particularly, a clip for actuating a knife blade between a closed position and an open position.

Discussion of the Related Art

Clips for securing a knife to clothing are well known in the art. Such clips typically protrude from the knife body and, therefore, can be obtrusive and snag on items when properly secured to an article of clothing, which can damage the clip, the pocket and/or the snagged item.

Therefore, with the above reasons in mind, there exists a need for knife clip which achieves the following: (1) conformity to the surrounding handle/barrel for aesthetic appeal; (2) low profile relative to the handle/barrel for added functionality and maneuverability for both conventional use of the knife as well as “trick” or “stunt” use of the knife; and (3) interchangeability of the clip and associated parts for user customization, service, replacement and/or repair.

### SUMMARY OF THE INVENTION

In accordance with one form of this invention, there is provided a clip assembly for use in combination with a knife, and the clip assembly including a housing; an elongated clip that is sized and configured for congruent receipt in the housing, the elongated clip having a proximal end and a distal end, and the elongated clip being securable to the housing by at least one clip pivot being located in a through hole near the proximal end of the elongated clip and extending the width of the elongated clip; a button spring held against the elongated clip for biasing the elongated clip toward a resting position, and the elongated clip being operational between the resting position and an open position by depressing the distal end of the elongated clip thereby causing the proximal end to pivotally rise; and first and second oppositely disposed access recesses on the housing each being sized and configured for permitting access to the at least one clip pivot when the elongated clip is in the open position for selective removal of the at least one clip pivot, the button spring and the elongated clip.

In accordance with one form of this invention, there is provided a clip assembly for use in combination with a knife, and the clip assembly including a housing; an elongated clip that is sized and configured for congruent receipt in the housing, the elongated clip having a proximal end and a distal end, and the elongated clip being securable to the housing by first and second oppositely disposed clip pivots each being located in a through hole near the proximal end of the elongated clip and extending the width of the elongated clip; a detent spring between the first and second oppositely disposed clip pivots for biasing the first and second oppositely disposed clip pivots against the housing; a button spring held against the elongated clip for biasing the elongated clip toward a resting position, and the elongated clip being operational between the resting position and an open position by depressing the distal end of the elongated clip thereby causing the proximal end to pivotally rise; and first and second oppositely disposed access recesses on the housing each being sized and configured for permitting access to the clip pivots when the elongated clip is in the open position for selective removal of the clip pivots, the button spring and the elongated clip.

### BRIEF DESCRIPTION OF THE DRAWINGS

For a fuller understanding of the nature of the present invention, reference should be made to the following detailed description, taken in conjunction with the accompanying drawings in which:

FIG. 1A is a front perspective view of the knife and clip of the present invention, wherein the knife is shown in the closed position;

FIG. 1B is a front perspective view of the knife and clip of the present invention, wherein the knife is shown in the open position;

FIG. 2A is a rear perspective view of the knife and clip of the present invention, wherein the knife is shown in the closed position;

FIG. 2B is a rear perspective view of the knife and clip of the present invention, wherein the knife is shown in the open position;

FIG. 3A is a side elevational view of the knife and clip of the present invention wherein the clip is in a first position;

FIG. 3B is a side elevational view of the clip of the present invention, shown in cross-section, wherein the clip is in a first position;

FIG. 4A is a side elevational view of the knife and clip of the present invention wherein the clip is in a second position;

FIG. 4B is a side elevational view of the clip of the present invention, shown in cross-section, wherein the clip is in a second position;

FIG. 5 is an exploded view of the knife and clip of the present invention;

FIG. 6A is a side elevational view of the knife and clip of the present invention; and

FIG. 6B is a cross-sectional view of the knife and clip of the present invention taken from line A-A on FIG. 6A.

Like reference numerals refer to like parts throughout the several views of the drawings.

### DETAILED DESCRIPTION OF THE PREFERRED EMBODIMENTS

Referring to the several views of the drawings, the clip of the present invention for use in conjunction with a knife 100 is shown and described herein and is generally indicated as 14.

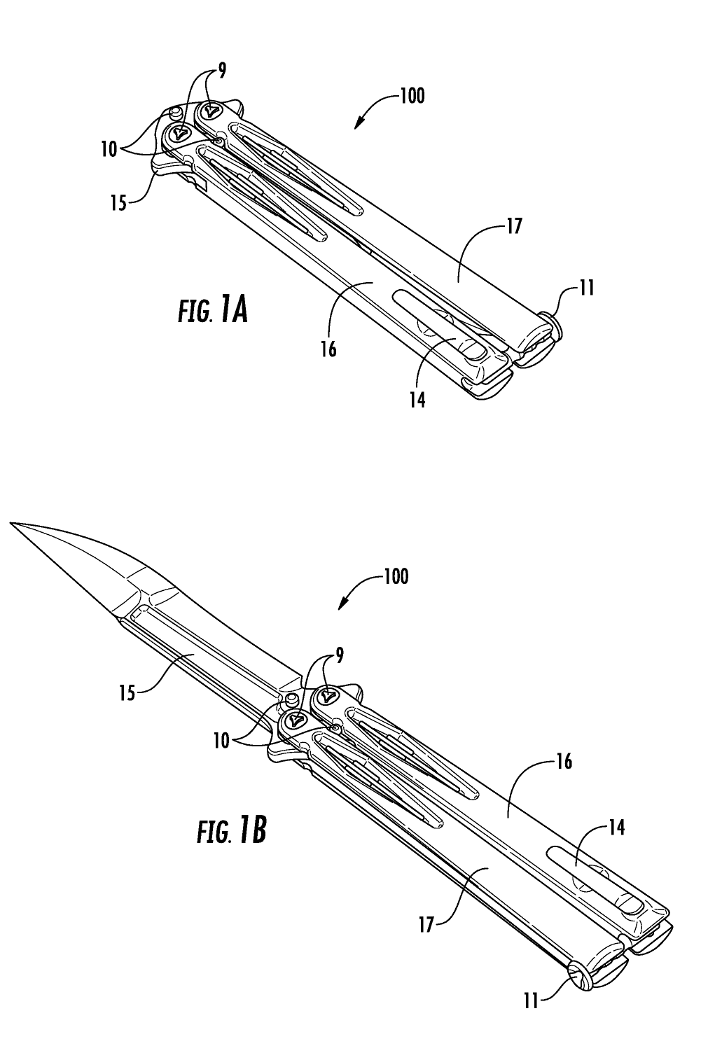

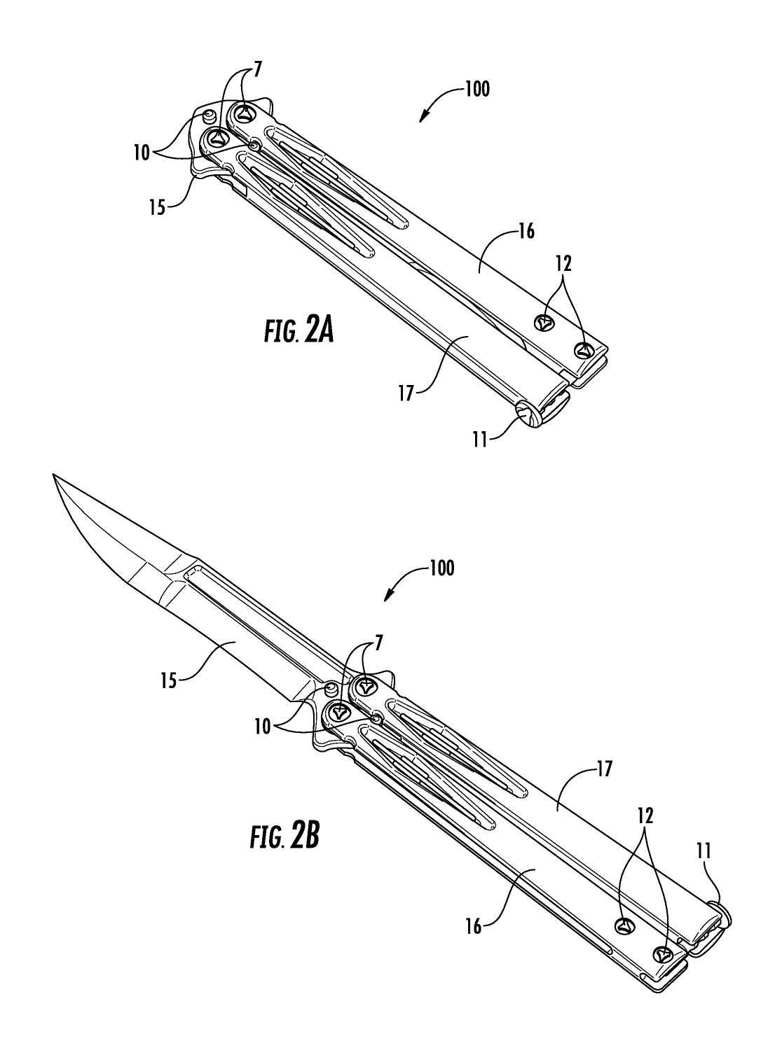

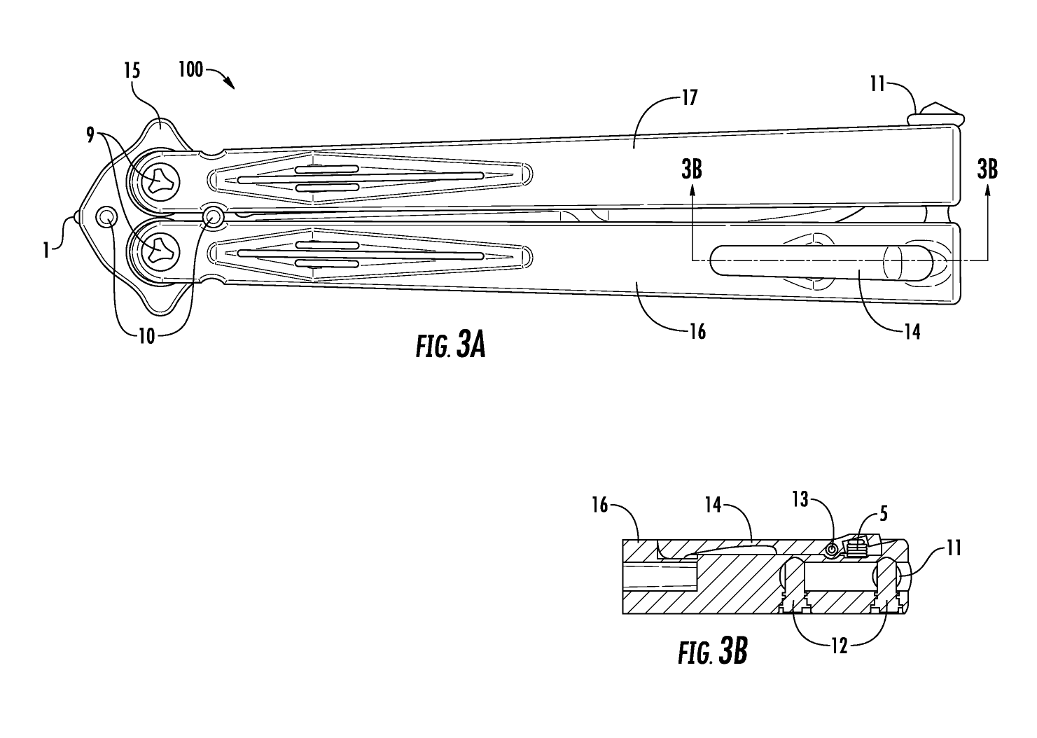

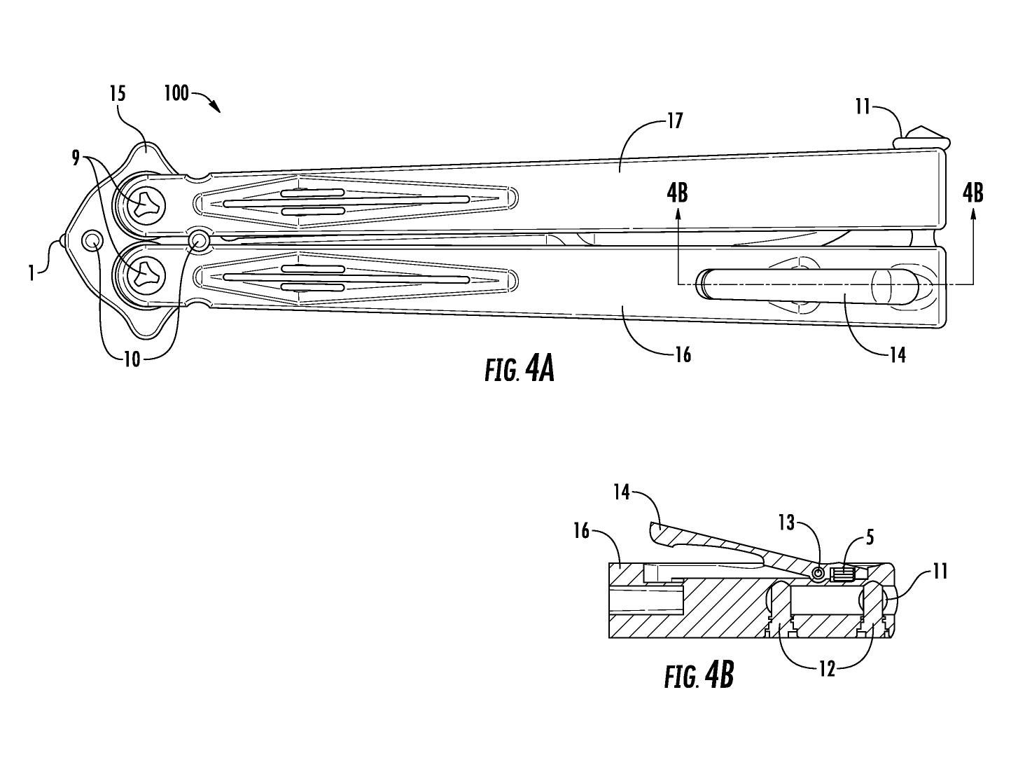

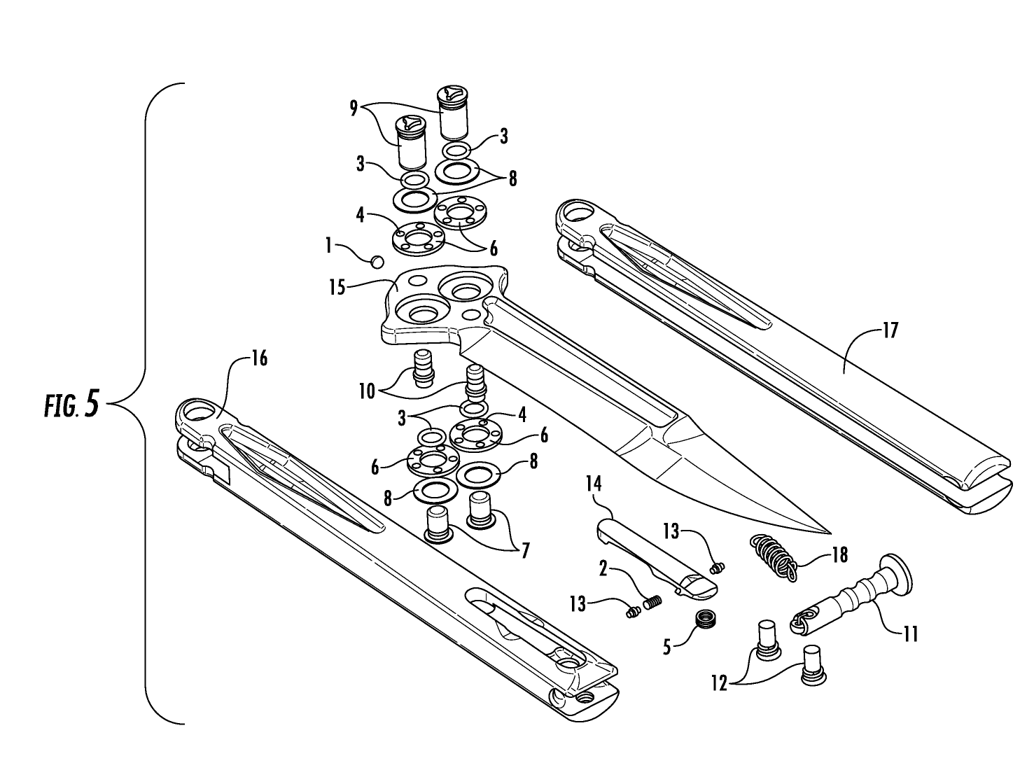

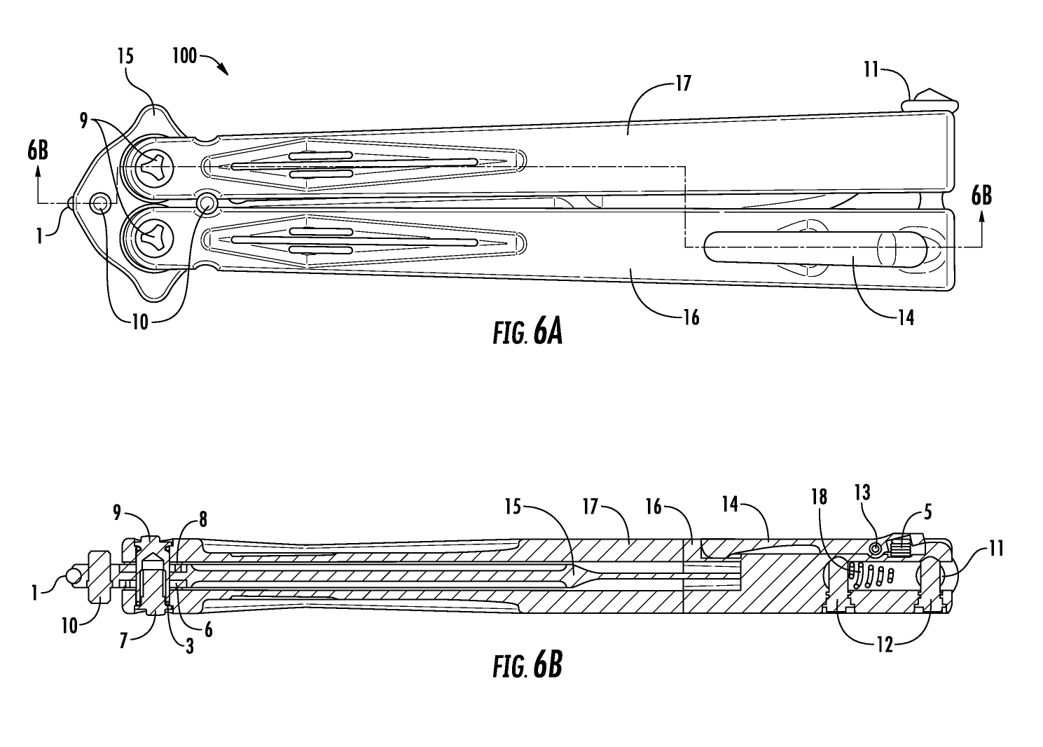

The attached FIGS. 1-6B, and most particularly FIG. 5, illustrate the above-noted features with reference to the following components in the illustrations:
1—breaker ball
2—detent spring
3—pivot o-ring
4—ball bearing
5—button spring
6—bearing race
7—pivot screw
8—bearing race plate
9—female pivot
10—stop pin
11—latch
12—latch screw
13—pocket clip pivot
14—pocket clip
15—clip point blade
16—right handle
17—left handle
18—latch spring
100—knife

The pocket clip 14 is secured to right handle 16 by first and second pocket clip pivots 13 which are located in a through hole extending the width of the pocket clip 14. The through hole is located within close proximity of the end of the pocket clip 14 at which it is depressed to raise the other end of the pocket clip 14 under which is a “bulbous” member that helps the pocket clip 14 engage an article of clothing. The end of the pocket clip 14 which is depressed to raise the other end has a raised area, above the surrounding handle/barrel surface, to facilitate the actuation process.

Each of the first and second pocket clip pivots 13 have a portion of the length that extends into grooves (one on each side) of the right handle/barrel 16. A detent/compression spring 2 is located in the through hole of the pocket clip 14 between the two pocket clip pivots 13. This detent spring 2 continuously applies pressure against the two pocket clip pivots 13, thereby pushing each outwards in opposing directions to keep them in the recessed grooves in the right handle 16. Each pocket clip pivot 13 has a decreasing diameter size change, smaller than the diameter interacting with the pocket clip 14, which protrudes into the detent spring 2 to give the pocket clip pivots 13 stability during operation of the knife 100 and guidance for the detent spring 2. A button spring 5 keeps pressure applied to the underside of the pocket clip 14 during the clip rest position as well as during operation. This spring 5 is located between the area at which the pocket clip 14 is depressed and the two pivots 13 which form the axis of rotation/pivot. The “bulbous” feature on the underside rests on the bottom floor of the main pocket clip recess in the right handle/barrel 16 when not engaged with clothing or when the opposite end is not being depressed.

Two access recesses, one on each side of the pocket clip pivot area and below the visible line of the user, allow the clip pivots 13 to be accessed when the pocket clip 14 is depressed for normal operation. These recesses allow a small tool to be inserted to depress the pivot 13 on each side thereby compressing the spring between the two pivots and allowing the pocket clip assembly to be removed from the handle 16 for maintenance and/or replacement.

While the present invention has been shown and described in accordance with several preferred and practical embodiments, it is recognized that departures from the instant disclosure are contemplated within the spirit and scope of the present invention.

What is claimed is:

1. A clip assembly for use in combination with a knife, and said clip assembly comprising:
a housing;
an elongated clip that is sized and configured for congruent receipt in said housing, said elongated clip having a proximal end and a distal end, and said elongated clip being securable to said housing by at least one clip pivot being located in a through hole near the proximal end of said elongated clip and extending the width of said elongated clip;
a button spring held against said elongated clip for biasing said elongated clip toward a resting position, and said elongated clip being operational between the resting position and an open position by depressing the distal end of said elongated clip thereby causing the proximal end to pivotally rise; and
first and second oppositely disposed access recesses on said housing each being sized and configured for permitting access to said at least one clip pivot when said elongated clip is in the open position for selective removal of said at least one clip pivot, said button spring and said elongated clip.

2. The clip assembly as recited in claim 1 wherein said at least one clip pivot includes first and second oppositely disposed clip pivots.

3. The clip assembly as recited in claim 1 wherein said elongated clip includes a bulbous member at the distal end of said elongated clip.

4. The clip assembly as recited in claim 2 further comprising a detent spring between said first and second oppositely disposed clip pivots for biasing said first and second oppositely disposed clip pivots against said housing.

5. The clip assembly as recited in claim 2 wherein each of said first and second oppositely disposed clip pivots has a decreasing diameter size change, wherein the diameter of each of said first and second oppositely disposed clip pivots decreases as the pivots extend outwardly from said elongated clip.

6. A clip assembly for use in combination with a knife, and said clip assembly comprising:
a housing;
an elongated clip that is sized and configured for congruent receipt in said housing, said elongated clip having a proximal end and a distal end, and said elongated clip being securable to said housing by first and second oppositely disposed clip pivots each being located in a through hole near the proximal end of said elongated clip and extending the width of said elongated clip;
a detent spring between said first and second oppositely disposed clip pivots for biasing said first and second oppositely disposed clip pivots against said housing;
a button spring held against said elongated clip for biasing said elongated clip toward a resting position, and said elongated clip being operational between the resting position and an open position by depressing the distal end of said elongated clip thereby causing the proximal end to pivotally rise; and
first and second oppositely disposed access recesses on said housing each being sized and configured for permitting access to said clip pivots when said elongated clip is in the open position for selective removal of said clip pivots, said button spring and said elongated clip.

7. The clip assembly as recited in claim 6 wherein said elongated clip includes a bulbous member at the distal end of said elongated clip.

8. The clip assembly as recited in claim 6 wherein each of said first and second oppositely disposed clip pivots has a decreasing diameter size change, wherein the diameter of each of said first and second oppositely disposed clip pivots decreases as the pivots extend outwardly from said elongated clip.
